(19) United States
(12) Patent Application Publication
(10) Pub. No.: US 2025/0242519 A1
(43) Pub. Date: Jul. 31, 2025

(54) THICKNESS PLANER

(71) Applicant: Weisshaus Rsearch Pty. Ltd., Hawthorn East (AU)

(72) Inventor: Jimmy Tsung-Hsun PAI, Hawthorn East (AU)

(21) Appl. No.: 18/693,372

(22) PCT Filed: Sep. 19, 2022
(86) PCT No.: PCT/AU2022/051122

§ 371 Date: Mar. 19, 2024

(30) Foreign Application Priority Data
Sep. 20, 2021 (AU) 2021903017
Feb. 8, 2022 (AU) 2022900247
Sep. 2, 2022 (AU) 2022902525

(51) Int. Cl. B27C 1/04; B27C 5/06

(52) U.S. Cl. CPC B27C 1/04; B27C 5/06

(57) ABSTRACT

A thickness planer comprising a main body which includes a base structure and a support structure, a cutter carriage adapted to have a cutter assembly operatively mounted thereto, when in an installed position, and a separate roller carriage adapted to have at least one roller assembly operatively mounted thereto, when in an installed position. The cutter carriage and the roller carriage are each mounted to the support structure and arranged so that when the thickness planer is in an in use configuration, the cutter carriage and roller carriage are substantially isolated or separated from one another. The arrangement inhibits or substantially reduces forces generated during use being transferred from the roller carriage to the cutter carriage.

### TECHNICAL FIELD

This disclosure relates generally to apparatus for use in the trimming or thicknessing of workpieces such as timber boards so as to provide for a substantially constant thickness along the length of the board.

### BACKGROUND ART

Basically machines of this type comprise a flat work table for supporting a workpiece during a trimming or thicknessing operation, a powered rotatable cutter, and powered feed rollers for drawing the workpiece along the table and past the cutter. The feed rollers and cutter are mounted to a carriage which is in turn is mounted to a part of the main structure of the machine. The table and carriage for the feed rollers and cutter may be height adjustable relative to one another in order to control the desired thickness of the workpiece resulting from the trimming or thicknessing operation. In some machines the carriage is fixed and the table is movable in order to effect the height adjustment. In other machines the table is fixed and the carriage is moveable in order to effect the height adjustment.

Currently known thickness planers often suffer from the phenomenon known as snipe. Snipe can be caused as a result of misalignment of the workpiece when being fed into the machine or changes in reaction forces on the feed rollers which form part of the apparatus this change in reaction forces on the rollers can cause movement of the cutter head relative to the workpiece leading to a deeper cut in the work piece at the leading and trailing edges thereof. The reaction forces on the feed rollers can result in vibrations or rattle between the rollers and cutter and the main structure of the machine to which the rollers and cutter are mounted.

### SUMMARY OF DISCLOSURE

In a first aspect, embodiments are disclosed of a thickness planer comprising a main body which includes a base structure and a support structure, a cutter carriage adapted to have a cutter assembly operatively mounted thereto, when in an installed position, and a roller carriage adapted to have at least one roller assembly operatively mounted thereto, when in an installed position, the cutter carriage and the roller carriage each being mounted to the support structure and arranged so that when the thickness planer is in an in use configuration, the cutter carriage and roller carriage are substantially isolated or separated from one another.

In certain embodiments, the cutter carriage and roller carriage are separate structures and independently and separately mounted to the support structure with a gap therebetween.

In certain embodiments, the carriages are mounted so as to not be in direct contact with one another. The arrangement is such that forces generated between the rollers, roller carriage and workpiece, during operation of the thickness planer, are inhibited from being transferred or translated from the roller carriage to the cutter carriage or at least substantially reduced in magnitude. In certain embodiments, the carriages are sufficiently spaced apart from one another so as to inhibit or substantially reduce the forces referred to above from being transferred from the roller carriage to the cutter carriage.

In certain embodiments, the arrangement is such that, in use, the cutter carriage holds the cutter head at one rest position and the roller carriage holds the rollers at another rest position relative to the cutter. The rest positions of the roller and cutter may be adjustable.

In certain embodiments, the base structure includes a top side, an infeed end and an outfeed end with a workpiece travel path having a travel path axis extending in a direction between the ends, wherein there are two roller assemblies mounted to the roller carriage when in the installed position in spaced apart relation to one another in the direction of the travel path axis, the cutter carriage and the roller carriage being configured so that the cutter assembly when in the installed position is disposed between the roller assemblies.

In certain embodiments, the cutter carriage includes a main section operatively mounted to the support structure and a cutter support section to which the cutter assembly is mounted, the cutter support section extending away from the main section towards the base structure, the roller carriage including a main body operatively mounted to the support structure, the main body having an opening therein which can receive the cutter support section.

In certain embodiments, the cutter carriage is positioned adjacent the base structure and the roller carriage is positioned above the cutter carriage when in the installed position.

In certain embodiments, the roller carriage is positioned adjacent the base structure and the cutter carriage is positioned above the roller carriage, the carriages being in spaced apart relation with respect to one another. In other embodiments, the cutter carriage is positioned below the roller carriage.

In certain embodiments, the roller carriage comprises two separate support rails laterally spaced apart with respect to the travel path axis, the rails being operatively mounted to the support structure and the or each roller assembly being operatively mounted to the support rails when in the installed position.

In certain embodiments, the carriage comprises two spaced apart and separated end sections each being operatively mounted to the support structure and each having a roller assembly operatively mounted thereto one being upstream of the cutter and the other being downstream of the cutter when in the installed position.

In certain embodiments, one or both of the roller assemblies comprise two rollers, one being a forward roller and the other a trailing roller, the rollers being mounted to a support frame which is pivotally mounted to the roller carriage for pivotal movement about a pivot axis, the pivot axis extending laterally with respect to the travel path, the rollers being located on opposite sides of the pivot axis.

In certain embodiments, the support frame comprises first and second frame sections each being pivotally mounted to the roller carriage in spaced apart relation with respect to one another, wherein the forward and trailing rollers have ends operatively connected to respective ones of the first and second frame sections.

In certain embodiments, the ends of the rollers are operatively mounted to the frame sections so as to be displaceable in a lateral direction with respect to the roller axes and the pivot axis.

In certain embodiments, the thickness planer includes a pressure applicator for urging the rollers in a direction towards the base structure in a substantially resilient fashion.

In certain embodiments, the pressure applicator comprises springs mounted so as to bias the rollers in the direction towards the base structure.

In certain embodiments, each roller assembly comprises a single roller operatively mounted to the roller carriage.

In certain embodiments, the planer includes an adjustment mechanism for adjusting the relative position of the base structure and the carriages towards or away from one another.

In certain embodiments, the adjustment mechanism is operable to move the carriages towards or away from the base structure.

In certain embodiments, the support structure comprises a plurality of columns operatively mounted to the base structure, the cutter carriage and roller carriage each comprising carriage mounts, the mounts being operatively connected to at least some of the columns so as to be movable therealong towards or away from the base structure.

In certain embodiments, the adjustment mechanism comprises cooperating threaded sections one being on at least some of the columns and the other associated with the carriage and roller mounts, the threaded sections being configured so that relative rotation therebetween causes the carriages to move along the columns.

In certain embodiments, the columns are mounted for rotation on the base structure so that rotation thereof causes movement of the carriages along the columns.

In certain embodiments, the thickness planer includes a transmission arrangement for facilitating simultaneous rotation of the columns.

In certain embodiments, the thickness planer includes a power train for powering the cutter head and the roller assemblies, the power train comprising a motor and a first transmission system operatively connecting the motor to the cutter head and a second transmission system operatively connecting the motor to the roller assemblies.

In certain embodiments, the thickness planer includes an air stream flow control apparatus for controlling a flow of air through regions of the planer, the air stream flow control apparatus including a first downdraught system which can direct an airflow from above towards the base structure, and a second updraft system, which is operable to draw air away on the base structure in an upwards direction.

In certain embodiments, the thickness planer includes an airstream guide including a feed section with an internal chamber therein and an inlet for delivering an airstream to the internal chamber, the guide further including a discharge section which includes a plurality of ducts in fluid communication with the internal chamber for directing the airstream towards the base structure.

In a second aspect, embodiments are disclosed of a roller assembly for use in a thickness planer, the roller assembly comprising a roller support frame mounted for pivotal movement about a pivot axis, two rollers each having a rotation axis, the rollers being mounted to the support frame, the roller rotation axes being substantially parallel to the pivot axis with one roller being located to one side of the pivot axis and the other roller being located to the other side of the pivot axis.

In certain embodiment, the support frame comprises first and second frame sections each being mounted for pivotal movement about the pivot axis and in spaced apart relation with respect to one another, the rollers having ends which are operatively connected to respective ones of the first and second frame sections.

In certain embodiments, the ends of the rollers are operatively mounted to the frame sections so as to be laterally moveably with respect to the roller axis and the pivot axes in a lateral direction towards an operative position.

In certain embodiments, the roller assembly includes a pressure applicator for urging the rollers in the lateral direction towards the operative position.

In certain embodiments, the pressure applicator comprises springs associated with each end of the rollers for biasing the rollers in the lateral direction towards the operating position.

In a third aspect, embodiments are disclosed of an airstream flow control apparatus for a thickness planer, the thickness planer including a base structure, a support structure and a cutter carriage, the airstream flow control apparatus being operatively mounted to the cutter carriage when installed and comprising a downdraft system for directing a flow of air from the cutter carriage towards the base structure and an updraft system for drawing air away from the support structure.

### BRIEF DESCRIPTION OF THE DRAWINGS

Notwithstanding any other forms which may fall within the scope of the method and apparatus set forth in the summary, specific embodiments of the method and apparatus will now be described by the way of example and with reference to the accompanying drawing in which:

FIG. 1 is a schematic side elevation of a thickness planer according to one embodiment;

FIG. 2 is a plan view of a base structure which forms part of the thickness planer shown in FIG. 1;

FIG. 3 is a side elevation of the base structure shown in FIG. 2;

FIG. 4 is an end elevation of the base structure shown in FIGS. 2 and 3;

FIG. 5 is a plan view of a cutter carriage which forms part of the thickness planer shown in FIG. 1;

FIG. 6 is a side elevation of the cutter carriage shown in FIG. 5;

FIG. 7 is an end elevation of the cutter carriage shown in FIGS. 5 and 6;

FIG. 8 is a side elevation of a cutter head according to one embodiment;

FIG. 9 is an end elevation of the cutter head shown in FIG. 8;

FIG. 10 is a detail of part of the cutter head shown in FIGS. 8 and 9;

FIG. 11 is a side elevation of a cutter head according to a further embodiment;

FIG. 12 is an end elevation of the cutter head shown in FIG. 11;

FIG. 13 is a plan view of a roller carriage which forms part of the thickness planer shown in FIG. 1;

FIG. 14 is a side elevation of the roller carriage shown in FIG. 13;

FIG. 15 is a side elevation of a part of the roller carriage shown in figure is 13 and 14;

FIG. 16 is an end elevation of that part of the roller carriage shown in FIG. 16;

FIG. 17 is a detail of part of the thickness planer shown in FIG. 1;

FIG. 18 is an exploded detail of a further part of the thickness planer shown in FIG. 1;

FIG. 19 is a view of that part of the thickness planer shown in FIG. 18 in an assembled position;

FIG. 20 is an exploded schematic view of an airstream guide which forms part of the thickness planer shown in FIG. 1;

FIG. 21 is a schematic view of the airstream guide shown in FIG. 20 in an assembled configuration;

FIG. 22 is a side elevation of part of the airstream guide shown in FIGS. 20 and 21;

FIG. 23 is an end elevation of that part shown in FIG. 22;

FIG. 24 is an isometric view of a planer according to another embodiment viewed from an infeed end and from one side;

FIG. 25 is an isometric view of the planer shown in FIG. 24 viewed from the infeed end and from the other side;

FIG. 26 is an isometric view of the planer shown in FIGS. 24 and 25 viewed from an outfeed end and from one side;

FIG. 27 is an isometric view of the planer shown in FIGS. 24 to 26 viewed from the outfeed end and from the other side;

FIG. 28 is a side elevation of part of the planer shown in FIGS. 24 to 27;

FIG. 29 is an underside plan view of that part of the planer shown in FIG. 28;

FIGS. 30 and 31 are elevation views of components shown in FIGS. 28 and 29;

FIGS. 32 and 33 are views of a further part of the planer shown in FIGS. 24 to 31;

FIG. 34 is a schematic exploded isometric view of part of part of the planer shown in FIGS. 24 to 33;

FIG. 35 is a schematic side elevation of that part of the apparatus shown in FIG. 34 but not in an exploded form; and

FIG. 36 is an isometric view of a planer according to yet another embodiment viewed from an infeed end and from one side.

FIG. 37 is a schematic side elevation of part of the planer according to another embodiment;

FIG. 38 is a schematic sectional view of that part of the planer shown in FIG. 37;

FIGS. 39 to 41 are schematic illustrations showing the operation of the part of the planer shown in FIGS. 37 and 38;

FIG. 42A is a perspective view of part of the planer according to another embodiment;

FIG. 42B is a schematic side elevation of part of the planer shown in FIG. 42A;

FIGS. 43A-430 are schematic views of various different arrangements of the parts of the planer according to further embodiments;

FIG. 44 is a side elevation of a part of the planer according to another embodiment;

FIG. 45 is an exploded view of that part shown in FIG. 44;

FIG. 46 is a detail of that part shown in FIGS. 44 and 45; and

FIG. 47 is a schematic sectional view of that part of the planer shown in FIG. 46.

### DETAILED DESCRIPTION

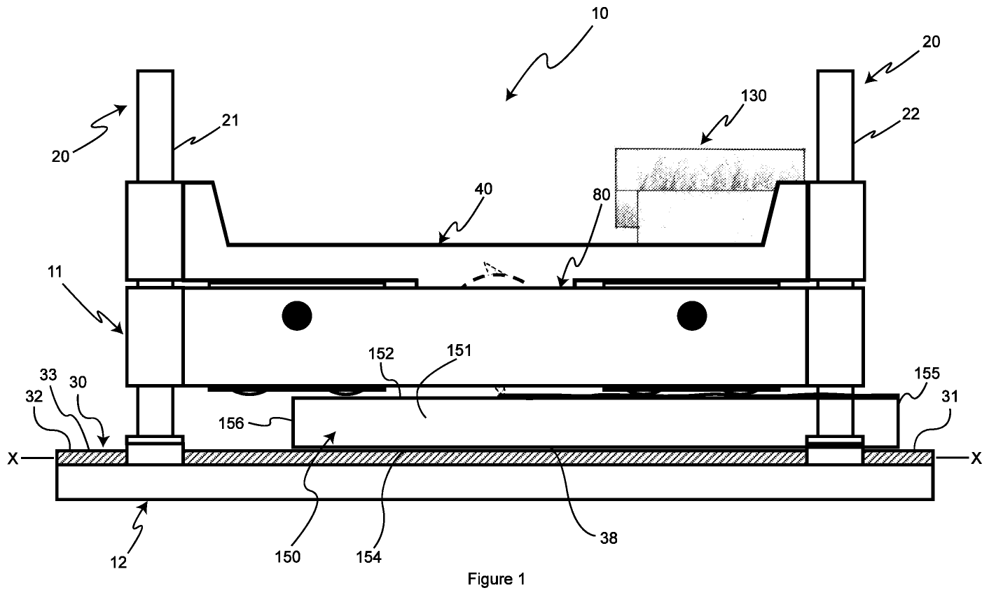

Referring to the drawings, there is illustrated a thickness planer generally indicated at 10 which is suitable for use in the trimming of a workpiece 150 which, in the form shown in FIG. 1 comprises an elongated timber board 151 having a top side 152, a bottom side 154 and opposed ends 155 and 156. The planer 10 can be used for trimming the workpiece 150 so that it is of a substantially constant thickness along its length between the ends 155 and 156.

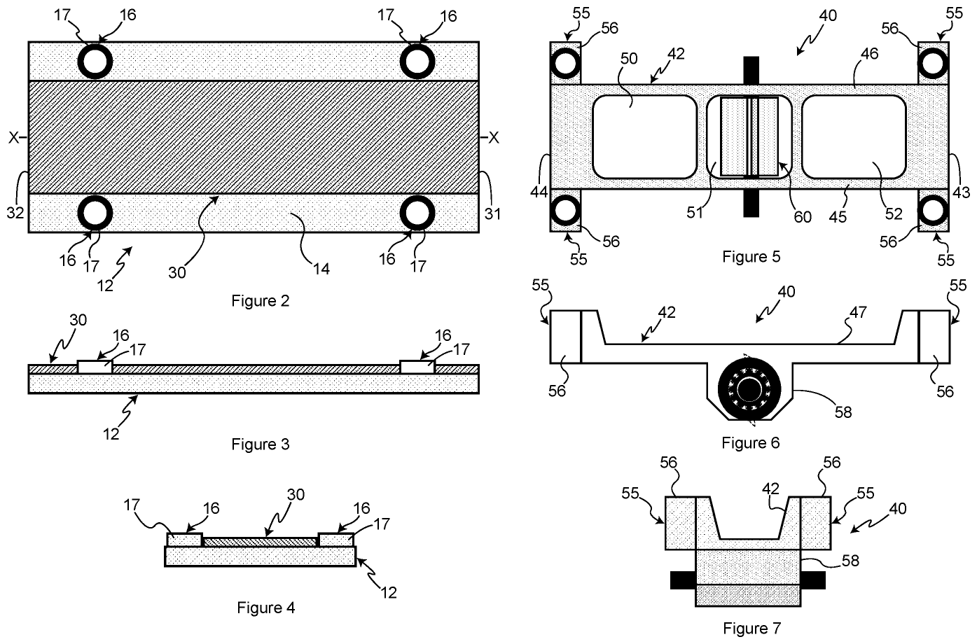

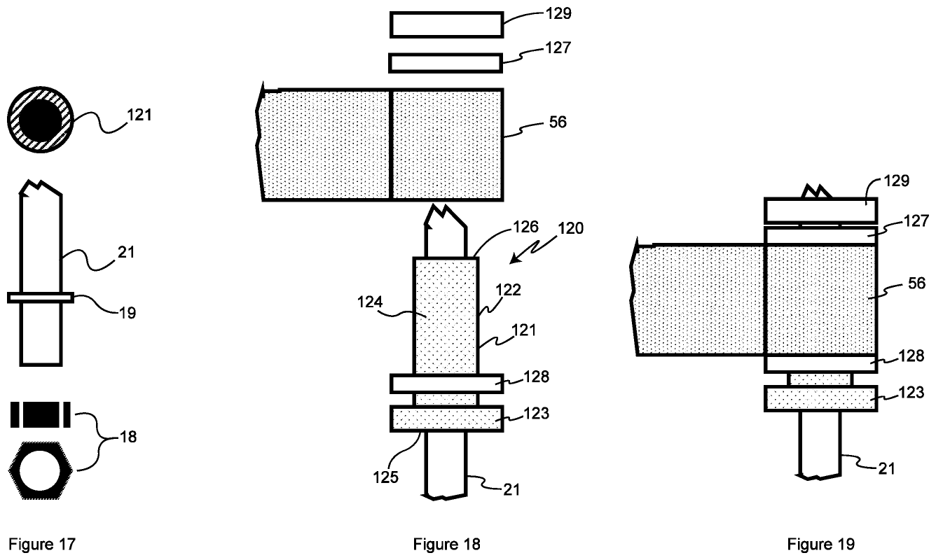

The thickness planer 10 comprises a main body 11 which includes a base structure 12 having a top side 14, the main body 11 further including a support structure 20 which is mounted to the base structure 12. The support structure 20 comprises a plurality of columns. In the embodiment shown there are four columns although only two columns 21 and 22 can be seen in FIG. 1. The columns are operatively mounted to the base structure 12 so as to extend away from the top side 14. When the planer is in an in use configuration, the columns are disposed in a generally upright orientation. As best seen in FIGS. 2 to 4, the base structure 12 comprises column mounts 16 to which the columns are secured. In the form shown, the column mounts 16 comprise bosses 17 having a hole therein which is adapted to cooperate and receive a lower end of the column. The column passes through the boss and the base structure. As shown in FIG. 17, the lower end of each column includes a threaded section which cooperates with a complementary threaded nut 18 to secure the column in position. Flange 19 on the column locates it in position.

The base structure includes a table 30 which is arranged to support the work piece 150 during a trimming operation. The table 30 includes an infeed end 31, and outfeed end 32 and a top surface 33. In use, the workpiece 150 is arranged to move from the infeed end 31 to the outfeed end 32 along a travel path in the direction of travel path axis X-X. The top surface 33 of the table 30 is substantially flat and provides a guide surface for the work piece 150 as it moves along the travel path.

The planer further includes a cutter carriage 40 which is operatively mounted to the support structure 20. A cutter assembly 60 is operatively mounted to the cutter carriage 40 and is configured so that in use, it can perform a trimming or planing operation on a work piece 150 as the workpiece moves along the travel path at a cutting zone 38. The cutter carriage 40 includes a main section 42 having spaced apart ends 43, and 44, spaced apart sides 45 and 46 extending between the ends, a top side 47 and underside 48. The main section 42 further includes a series of through holes 50, 51 and 52 arranged side by side between the ends 43 and 44, the through holes extending from the top side 47 to the underside 48. The main section further includes mountings 55 for mounting the cutter carriage 42 to the support structure 20. As described earlier, in the embodiment illustrated the support structure 20 comprises a plurality of columns 21, 22. In this particular embodiment, the mountings 55 comprises tubular members 56 having a bore extending therethrough for receiving one of the columns. The arrangement is such that the tubular members 56 and therefore the cutter carriage can be moved along the columns for reasons which will become apparent.

The cutter carriage 40 further includes a cutter support section 58 to which the cutter assembly 60 can be mounted. The cutter support section 58 extends away from the underside 48 of the main section 42 towards the table 30.

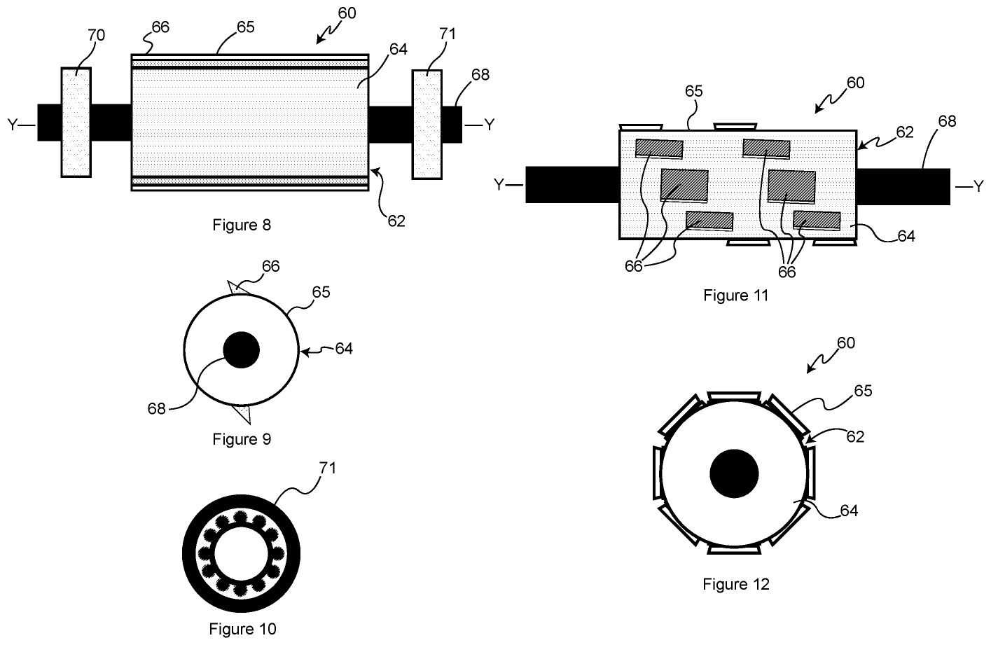

The cutter assembly 60 includes a cutter head 62 mounted to the support section 58 for rotation about a rotation axis Y-Y. The rotation axis Y-Y extends laterally and preferably substantially at right angles with respect to the travel path axis X-X. The cutter head 62 comprises a generally cylindrical body 64 having an outer peripheral surface 65 to which cutter elements 66 are secured. The cutter head 62 is mounted to a driveshaft 68 which is supported by bearings 70 and 71 in the cutter support section 58. The drive shaft 68 is operatively connected to a motor (not shown) so as to cause rotation of the cutter head 60. The cutter elements 66 may be in the form of elongated straight blades 67 which extend from one end of the cylindrical body 64 to the other and are disposed and spaced apart relation to one another around the peripheral surface 65 (FIG. 8). In another embodiment, the cutter elements comprise a series of cutter blades arranged in a helical pattern around the peripheral surface 65 (FIG. 11).

The planer 10 further includes a roller carriage 80 to which roller assemblies 100 and 101 are operatively mounted. In use, one of the roller assemblies 100 is disposed upstream of the cutter head 62 and the other roller assembly 101 is disposed downstream of the cutter head 62. The carriage 80 comprises a main body 82 having a top side 83, bottom side 84, opposed ends 86 and 87 and sides 88 and 89. The main body 82 comprises an opening 90 through which the cutter head 62 can extend. The opening 90 is sized so that the support section 58 and cutter head 62 are in spaced apart relation from the main body of the roller carriage. The main body 82 comprises mounts 93, 94, 95, 96 for mounting the carriage to the columns. Each roller assembly 100 and 101 comprises two rollers 104 and 106 each having a roller axle 107 which projects from the roller ends each end of the axle being mounted to a support frame 110. The support frame 110 is pivotally mounted to the main body.

Each roller assembly 100 and 101 comprises two rollers, one being a forward roller 104 and the other being a trailing roller 106. Each roller 104 and 106 has a rotation axis Z-Z which extends laterally and preferably substantially at right angles with respect to the travel path axis X-X. The support frame 110 comprises first and second frame sections 111 and 112 to which the ends of the rollers are operatively mounted. The frame sections 111 and 112 are pivotally mounted to the main body 82 of the carriage 80 by means of pivot pins 113. The rotation axis of each roller and the pivot axis P-P of the pivot pins are substantially at right angles to the travel path axis X-X. When viewed in plan, the forward roller 104 is disposed to one side of the pivot axis P-P and the trailing roller 106 is disposed to the other side of the pivot axis. The ends of each roller are operatively connected to respective ones of the first and second frame sections 111 and 112 by means of a connector assembly 114. The connector assembly 114 includes a bushing block 115 to which the ends of the rollers are attached. The bushing blocks 115 are in the form of a block disposed within a housing 116 in each frame section 111 and 112. The housing 116 is in the form of a slot 117. The blocks 115 are displaceable within the housing in a lateral direction with respect to the roller rotation axes and the pivot axis P-P. Each block 115 has a pressure applicator 118 associated therewith for urging the members in a direction towards the table 30. The pressure applicator 118 comprises a spring 119 disposed within the housing 116. A closure 108 closes the housing 116. At least one of the rollers 104 and 106 associated with each of the roller assemblies 100 and 101 is driven. For example in one embodiment, only one of the rollers 104 and 106 in each assembly 100 and 101 is driven and in another embodiment both of the rollers 104 and 106 are driven. The driven rollers are operatively connected to a suitable drive such as a motor which may conveniently be the same motor which drives the cutter.

The provision of roller assemblies 100 and 101 each comprising two rollers 104 and 106 tends to balance the pressure applied to the rollers as the workpiece passes through the planer. The arrangement assists in ensuring all rollers have good traction on the workpieces particularly where the workpiece may have a rough or uneven surface.

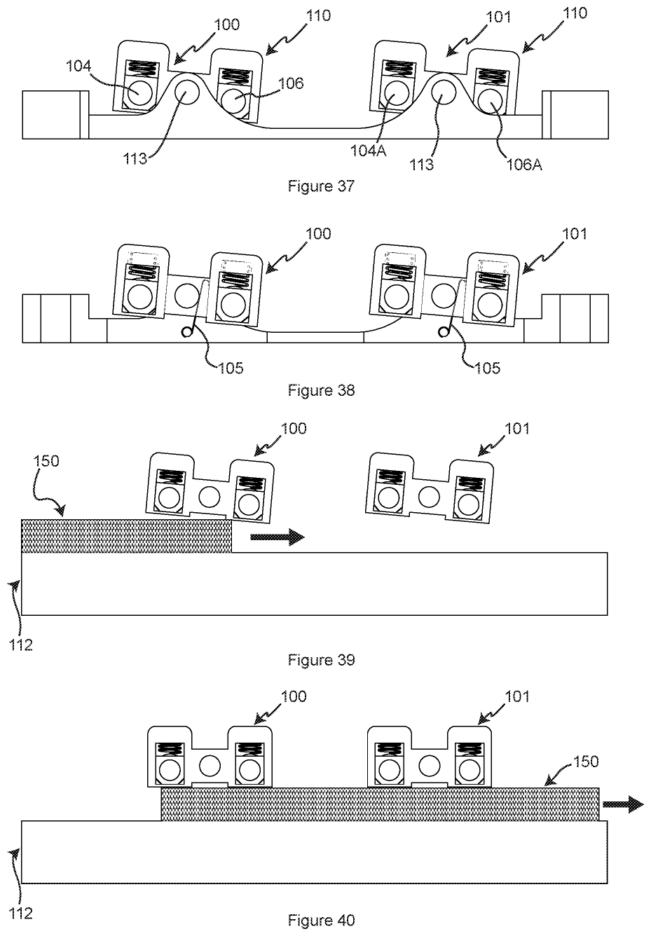

Another embodiment of roller assembly is shown in FIGS. 37 and 38. The arrangement is similar in structure to that described earlier and like reference numerals have been used in FIGS. 37 and 38 to those used in the description of the earlier embodiment. In the embodiment illustrated in FIGS. 37 and 38 the roller support frame 110 is configured so that, in an initial position, the forward roller 104 is disposed above the trailing roller 106 when viewed from the side. As shown the support frame is inclined when in the position; that is a line extending between the rotation axes of the forward ad trailing rollers. The support frame is resiliently biased into this initial position. In the embodiment shown this is effected by means of a spring bias and may be for example by means of leaf springs 105. In another embodiment, the inclination may be achieved by configuring the support frame to adopt this inclination in a natural fashion without the need for the leaf springs.

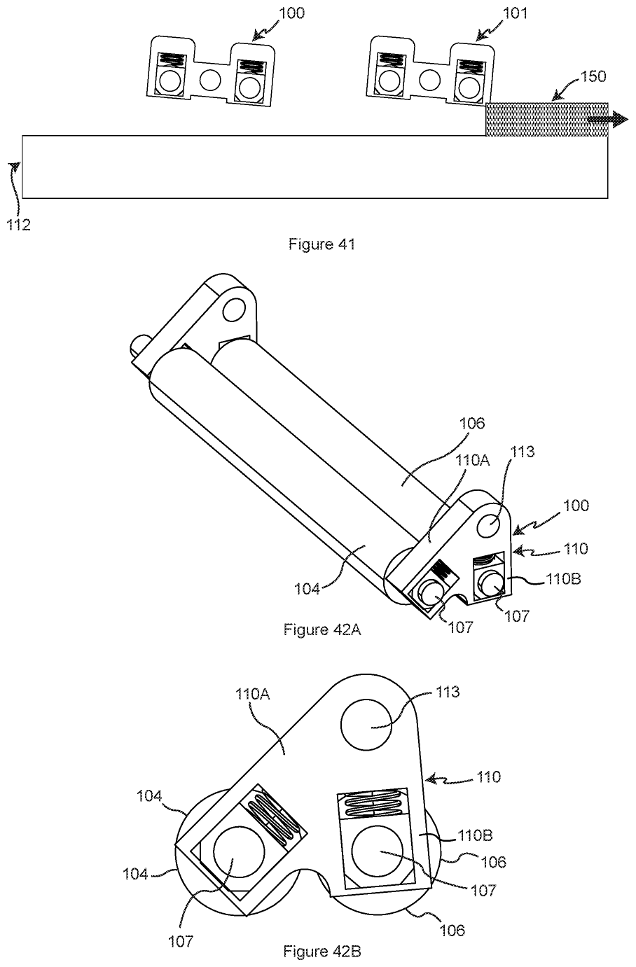

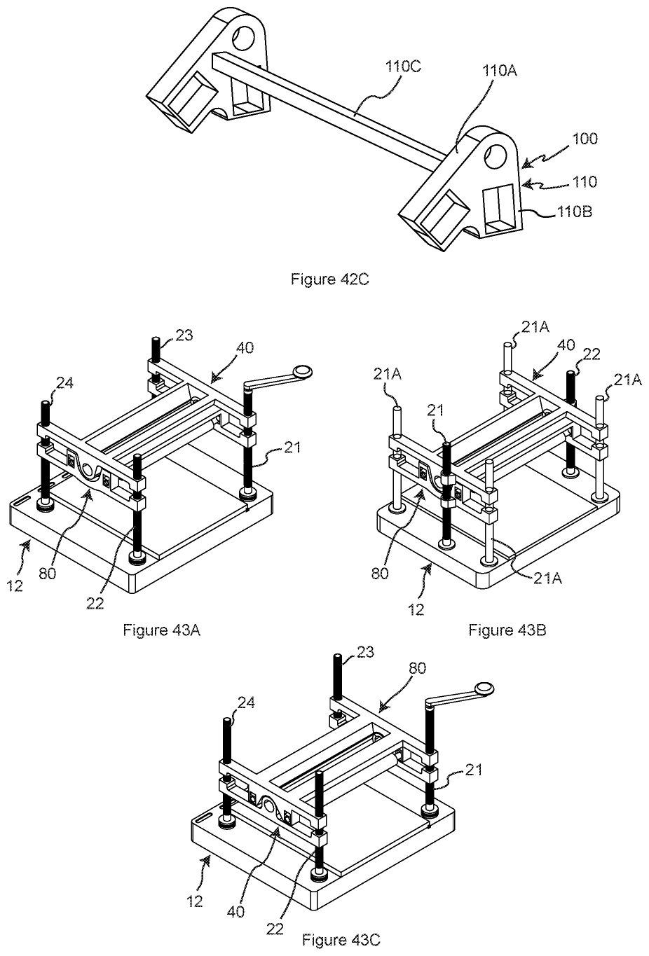

The operation of this arrangement is shown in FIGS. 39 to 41. As shown in FIG. 39 the workpiece 150 can be fed to the roller assembly 100 with minimal resistance. As the workpiece passes under the roller assembly the workpiece 150 strikes the trailing roller 106 causing the frame 110 to pivot so that the forward roller contracts the workpiece. This sequence is the same for both the upstream and downstream roller assemblies 100 and 101. Once the workpiece has moved passed the roller assemblies, the rollers will return to the *initial* position under the influence of leaf springs 105. FIGS. 42A and 42B illustrate a further embodiment of roller assembly. FIG. 42C illustrates a further embodiment, where the two support frames at the ends of the roller are interconnected by a cross member 110C. Roller assembly 100 is illustrated but it will be apparent that roller assembly 101 could be of the same structure. As shown, the roller assembly 100 comprises an upstream or forward roller numeral 104 and a downstream or rearward roller 106 operatively mounted to a roller support frame 110 which is pivotally mounted to the roller carriage via pivot pin 113. In this embodiment, the roller frame 110 comprises two arms 110A and 110B which are inclined with respect to one another; that is a line taken from pivot pin 113 to the axis of rotation of roller 104 is inclined to a line taken from pivot pin 113 to the axis of rotation of roller 106. Furthermore, the distance between the pivot pin 113 and the axis of roller 104 is greater than the distance between pivot pin 113 and the axis of rotation of roller 106. In all embodiments, the pivot pin 113 is positioned further away from the base structure at 12 than the axes of rotation of rollers 104 and 106. The arrangement is such that, when in use, a relatively small tilt of the frame 110 caused as a workpiece contacts and moves past the trailing roller 106 causes a larger clampdown force on the forward or upstream roller 104.

The planer 10 further includes an adjustment mechanism 120 for raising and lowering the cutter carriage 40 and the roller carriage 80 so they can be moved towards or away from the table 30. Each of the carriages 40 and 80 has a separate adjustment mechanism associated therewith. In the embodiment described, there are four columns each having an individual actuator associated therewith. This is the case for both of the carriages 40 and 80. As shown in FIGS. 18 and 19, the adjustment mechanism 120 comprises an actuator 121 which is arranged to cooperate with a column 21 for example to cause the movement of the carriage with which it is associated along the column. In one example embodiment, there is an actuator 121 associated with each column. The actuator 121 comprises an actuator body 122 having opposed ends 125 and 126. The actuator body 122 includes a head 123 at one end 125 and a shank 124 extending from the head and terminating at the other end 126. The shank 124 is sized so that it is receivable within one of the tubular members 56 on each of the carriages. This is illustrated in FIG. 19. The actuator body 122 has a bore therein which extends through the body from one end 125 to the other end 126. The bore is threaded and arranged to cooperate with a complementary threaded section of the column 21. When fitted, thrust bearings 127 and 128 are provided at each end of the tubular member 57 and a locknut 129 retains the assembly in place. The head 123 is shaped in the form of a hexagonal nut and rotation thereof within the member 56 will cause movement of the carriage along the column. The actuators 121 associated with the cutter carriage 40 may be provided with a transmission arrangement (not shown) which enables the actuators to be operated simultaneously. In one example embodiment, the actuator body of each actuator has a chain cog thereon, the chain cogs being arranged to cooperate with a chain which extends around the cogs and operable to cause simultaneous rotation thereof. The actuators associated with the roller carriage 80 may include a similar transmission arrangement.

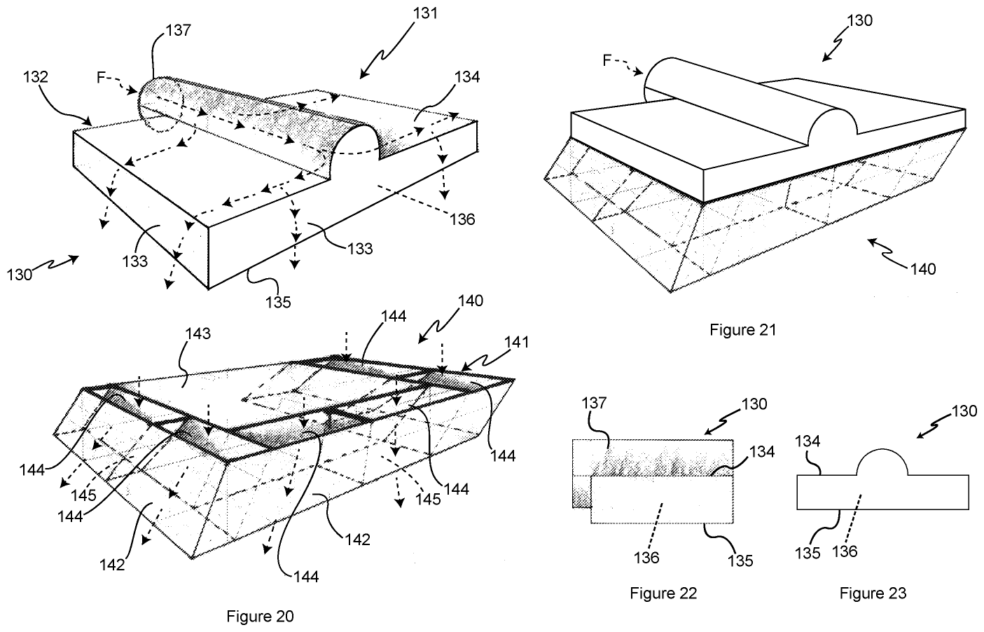

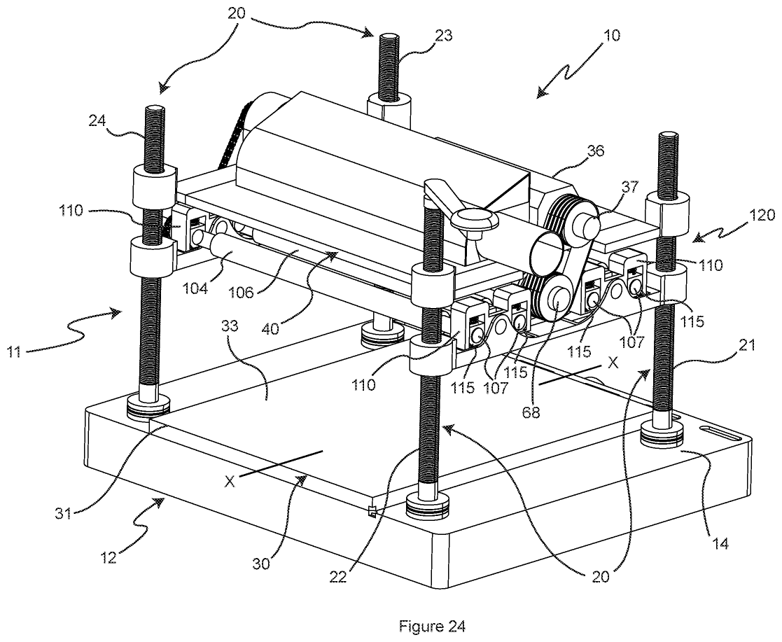

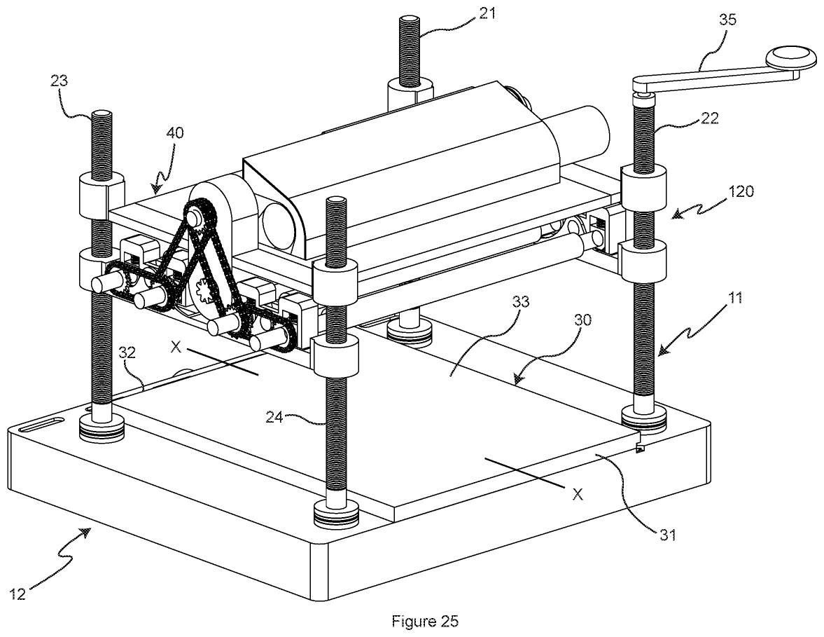

The planer further includes an airstream guide 130 for controlling the direction of flow of a stream of air from a blower, which forms part of the motor 36 (not shown). The guide 130 is configured to direct the airstream towards the table 30. The guide 130 is mounted to the cutter carriage 40 in the region of opening 52 in the cutter carriage so that it is disposed above the infeed end 31 of the table 30. As shown in FIGS. 20 to 23, the guide 130 comprises two parts, one being a feed section 131 and the other being a discharge section 140.

The feed section 131 comprises a main body 132 having four side walls 133 and a top wall 134. The main body 132 further includes an open underside 135 with an interior chamber bounded by the walls. An inlet 137 is configured to deliver air to the interior chamber 136.

The discharge section 140 comprises a main body 141 including side walls 142 and a top wall 143. As shown, the side walls are splayed or inclined outwardly from the top wall. A series of ducts 144 extend around the side walls for discharging air from the interior chamber 136 to the table 30. The ducts 144 include internal walls 145 arranged to direct discharged air to different regions of the table 30.

The arrangement is such that the airstream is directed toward the front and side of the table so as to keep it substantially free of any dust build up when in use.

The operation of the thickness planer will hereinafter be described. Once the final thickness of the board which is to be the subject of the operation is decided, the position of the cutter carriage 40 and the roller carriage 80 is raised or lowered by the adjustment mechanism until the cutter head 62 and rollers 100 and 101 are positioned at the desired location above the upper surface 33 of the table 30. The carriages are moved synchronously along the support structure to adjust the desired depth of cut. Furthermore, the carriages are configured so that the bottom of the roller is slightly closer (for example 0.1-0.5 mm) to the table than the bottom of the cutter plane. When in position for use, the cutter carriage 40 and roller carriage 80 are positioned relative to one another so that they are spaced apart or isolated from one another with a gap therebetween. In some trimming operations it may be desirable that one surface of the workpiece is subjected to a pre-treatment operation by means of a surface planer or jointer. This pre-treated flat surface will be disposed on the table 30 to ensure that the workpiece is properly positioned on that surface. The thickness planer is then ready for use and the motor or motors are activated to rotate the rollers 100 and 101 as well cutter head 62. One end of the work piece is then fed into the opening between the upstream roller assembly 101 and the table 30. The work piece contacts the rollers and is drawn into the planer sliding along the table 30 towards the cutting zone 38 where the cutting or trimming operation is effected by the rotating cutter head 62. The pivotally mounted rollers provide for compensating forces on the workpiece should it move in an undesirable fashion as it slides along the table. The spring loaded rollers also apply a pressure on the work piece so that it properly seats against the table 30. Once the leading end of the workpiece passes through the cutting zone it is then received by and moved through the downstream rollers whereafter it exits the machine. Because the cutter head is substantially isolated from the rollers any reaction forces caused by the rollers has a reduced or minimal effect on the cutter head.

FIGS. 24 to 35 illustrate a further embodiment of thickness planer. The thickness planer is similar in structure and method of operation to that of the first embodiment although there are some structural differences. As a matter of convenience and where appropriate the same reference numerals will be used to identify similar features in both embodiments and not described again in the following.

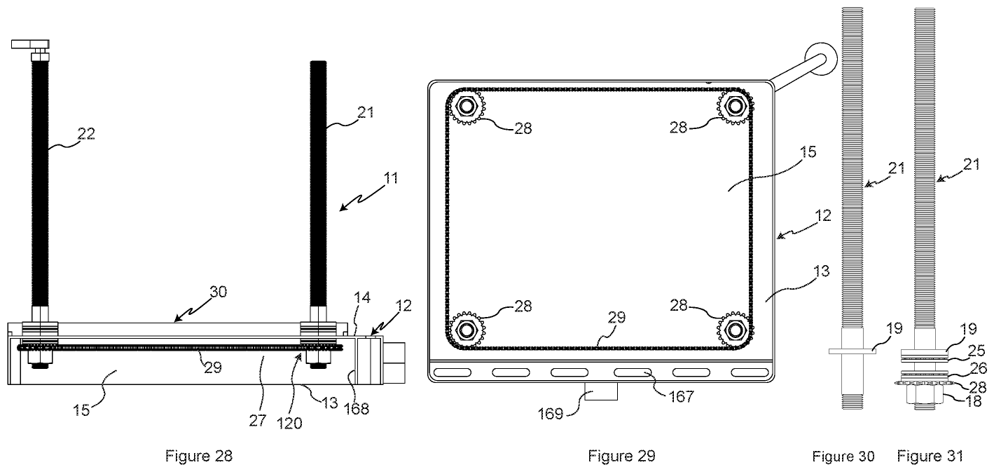

As shown in FIGS. 24 to 29, the thickness planer 10 comprises main body 11 which includes a base structure 12 having a top side 14 and an underside 13. As best shown in FIGS. 28 to 29, the underside 13 has a recess or cavity 15 therein. As shown in FIGS. 24 to 29, the main body 11 further includes a support structure 20 which is mounted to the base structure and comprises four columns 21, 22, 23, 24. The columns are operatively mounted to the base structure so as to extend away from the top side 14 and are disposed in a generally upright orientation.

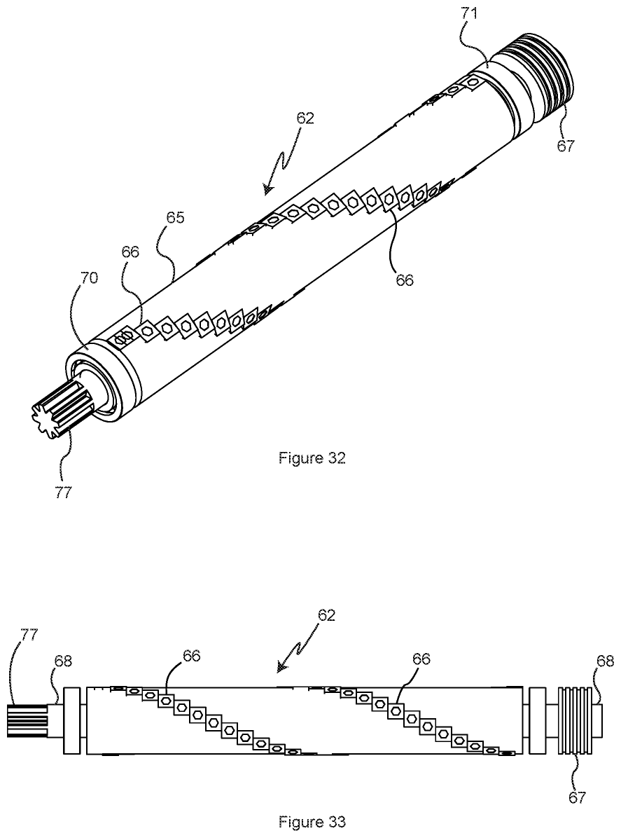

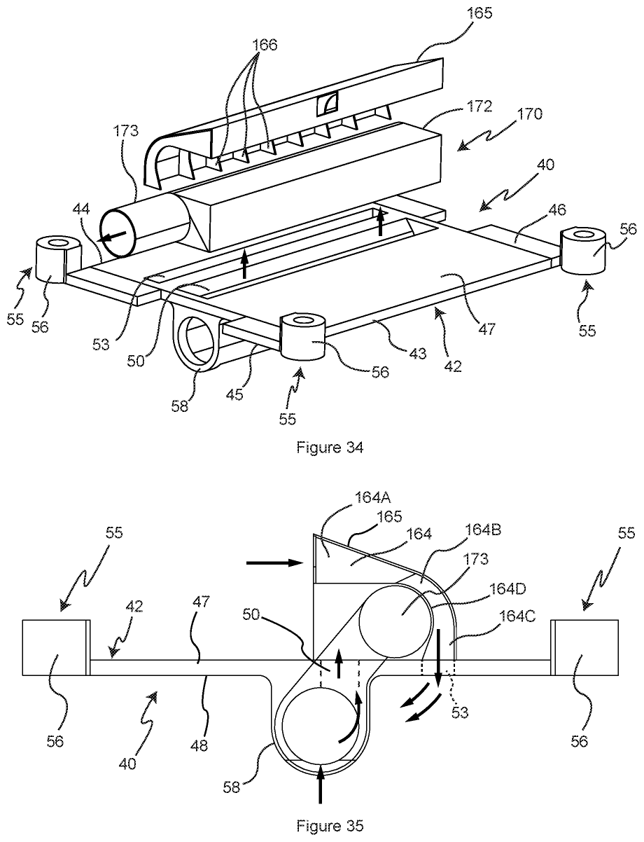

In this embodiment, the four columns 21, 22, 23 and 24 are mounted to the base structure so as to be rotatable about their longitudinal axes. To this end, two thrust bearings 25 and 26 are fitted to a lower end region of each column (FIG. 31). When assembled to the base structure 12, one thrust bearing 25 is located on the top side 14 of the base structure and the other thrust bearing 26 is located on the underside 13 and within the recess or cavity 15. As shown in FIGS. 28 and 29, each column has a sprocket 28 fitted thereto for reasons which will become apparent. A threaded nut 18 and complementary threaded section of each column secures the column in position on the base structure 12. The planer 10 further includes a table 30 which is disposed on the top side of the base structure and is arranged to support the work piece 150 (FIG. 1) during a trimming operation. The table 30 is in essence the same and is similarly configured to that described with reference to the first embodiment.

The planer includes a cutter carriage 40 which is operatively mounted to the support structure 20. This is clearly illustrated in FIGS. 34 and 35. The cutter carriage 40 is similar to that of the first embodiment and includes a main section 42 having spaced apart ends 43 and 44, spaced apart sides 45 and 46 extending between the ends, a topside 47 and an underside 48. In this embodiment, two through holes 50, 53 are provided which extend from the top side to the underside. The main section further includes mountings 55 for mounting the cutter carriage to the support structure 20. The mountings 55 comprise tubular members 56 having a threaded bore extending therethrough which is adapted to mesh with a threaded section of respective columns 21, 22, 23 and 24. As such, the cutter carriage 40 can be moved along the columns as a result of rotation of the columns.

As best seen in FIGS. 34 and 35, the cutter carriage 40 further includes a cutter support section 58 to which the cutter assembly 60 can be mounted. The cutter support section 58 extends away from the underside 48 of the main section 42 towards the table 30.

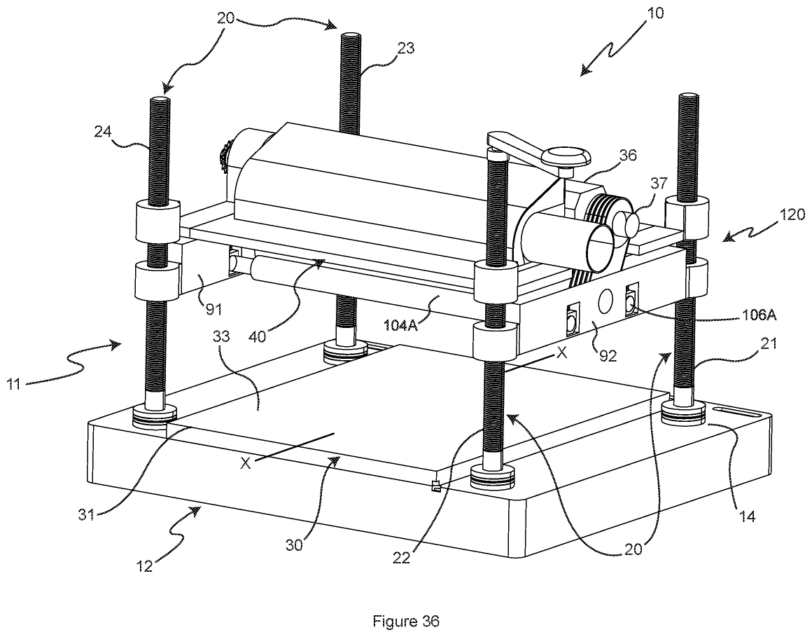

A cutter assembly is provided which comprises a cutter head 62 which is similar in structure to that described with reference to the first embodiment, and the same numerals have been used to identify the same parts in each case. The driveshaft 68 is operatively connected to a motor which forms part of a power drive train so as to cause rotation of the cutter head 62. Details of the motor and associated power drive train will be described later. In this embodiment, the cutter elements comprise a series of cutter blades 66 arranged in a helical pattern around the peripheral surface 65, as shown in FIGS. 32 and 33. The drive shaft 68 has a pulley 67 at one end and a gear cog 77 at the other end. These components form part of the power drive train which will be described later.

The planer 10 further includes a roller carriage 82 to which roller assemblies 100 and 101 are operatively mounted. In use, the roller assembly 100 is upstream of the cutter head and assembly 101 is downstream. The roller carriage 80 differs from the first embodiment in that it comprises two support rails 91 and 92. Each support rail 91 and 92 comprises respective mounts 93, 94, 95 and 96 at the ends of the rails. Support rail 91 is operatively mounted to and extends between columns 21 and 22. In a similar fashion, support rail 92 is operatively mounted to and extends between columns 23 and 24. The column mounts have threaded sections which intermesh with threaded sections of the columns so that rotation of the columns will cause the carriage to be raised or lowered. The roller assemblies 100 and 101 are similar in structure to that of the first embodiment. Each roller assembly 100 and 101 comprises two rollers 104 and 106, each having a roller axle 107 mounted to a support frame 110. The configuration may include a bushing block 115 similar to that described earlier. The support frame 110 is pivotally mounted to the rails through pivot pin 113 in a similar fashion as has been described with reference to the first embodiment.

The adjustment mechanism 120 is comprised by the threaded column mounts 55, 93, 94, 95 and 96 on the cutter and roller carriages 40 and 80 which cooperate with the threaded sections on the columns 21, 22, 23 and 24. Rotation of the columns causes the column mounts to move along the columns. The adjustment mechanism further includes a transmission arrangement 27 configured to cause simultaneous rotation of the four columns. The transmission arrangement 27 comprises four sprockets 28 and a chain 29 which extends around the sprockets 28. An actuator in the form of a manually operated crank handle 35 is provided on one of the columns. Rotation of the crank handle and rotation of the column with which it is associated cause simultaneous rotation of all of the columns through the chain and sprocket transmission arrangement.

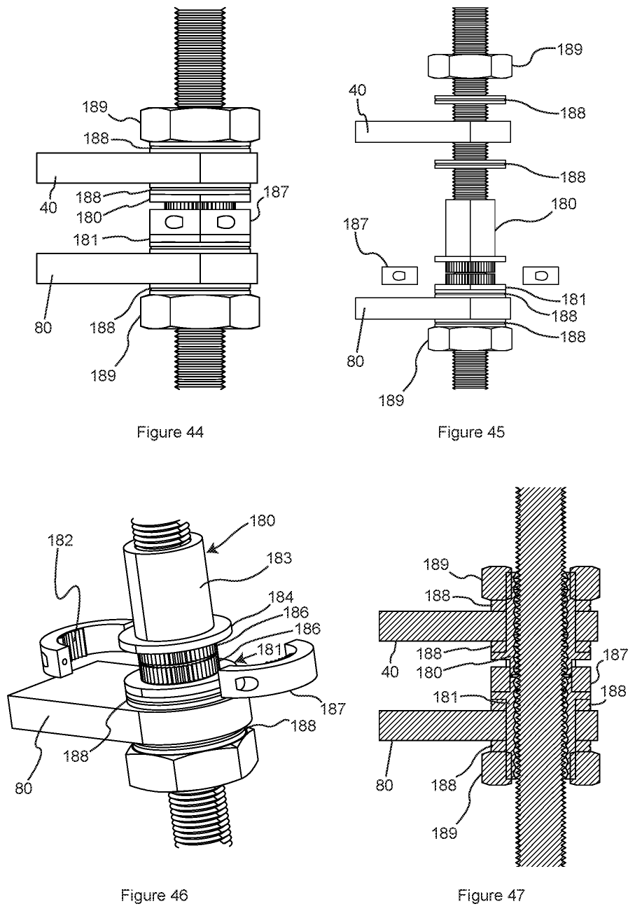

A further embodiment of adjustment mechanism is illustrated in FIGS. 44 to 47. In this arrangement, the threaded columns are fixed against rotation. The arrangement comprises two lug nuts 180 and 181 each being associated with a respective one of the cutter and roller carriages 40 and 80. Each lug nut 180 and 181 comprises a cylindrical body 183, a collar 184 and a cog wheel 186 having teeth thereon. The lug nuts have an internal threaded section configured to meshingly engage with the threaded section of a column. The carriages are operatively mounted to a respective one of the lug nuts which are configured so that the cogwheels 186 are adjacent one another but in spaced apart relation. An internally threaded activating nut 187 is mounted so as to engage with both of the cogwheels 186. The activating nut 187 has a toothed section 182 which is adapted to engage with the teeth of the cogwheels 186. The toothed section 102 extends partially around the external surface of the activating nut 187. As shown, the activating nut 187 is a two piece structure which enables it to be fitted. Thrust bearings 188 are provided on both sides of each carriage and lock nuts 189 arranged to hold and lock the assembly together. Rotation of the activating nut 187 will cause simultaneous rotation of the lug nuts 180 and 181 so as to raise or lower the carriages towards or away from the base structure. A chain and sprocket arrangement similar to that described with reference to the first embodiment can be used to drive each arrangement in unison.

The apparatus includes a power train for powering the cutter head 60 and roller assemblies 100 and 101. The power train, as illustrated in FIGS. 24 to 27, comprises a motor (not shown) housed within a motor housing 36 which is mounted to the cutter carriage 40. The motor includes a driveshaft 37 which is operatively connected to the cutter shaft 68 at one end thereof by series of pulleys 67 and 69 on both the motor shaft 37 and cutter shaft 68 and a number of belts 72.

The other end in the cutter shaft 68 is operatively connected to a gearbox 73 which in turn is operatively connected to a chain transmission. The chain transmission system includes a main drive sprocket 74 which is connected to the gearbox and drives the chains 75 which extend from the drive sprocket and are associated with respective ones of the rollers in each group. Connector chains 76 link the two rollers in each group so that all of the rollers are driven.

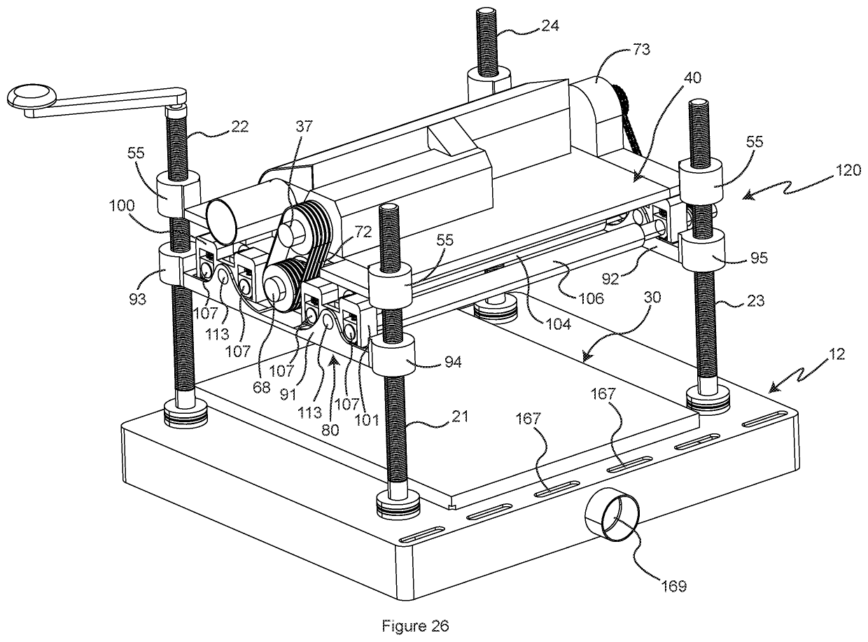

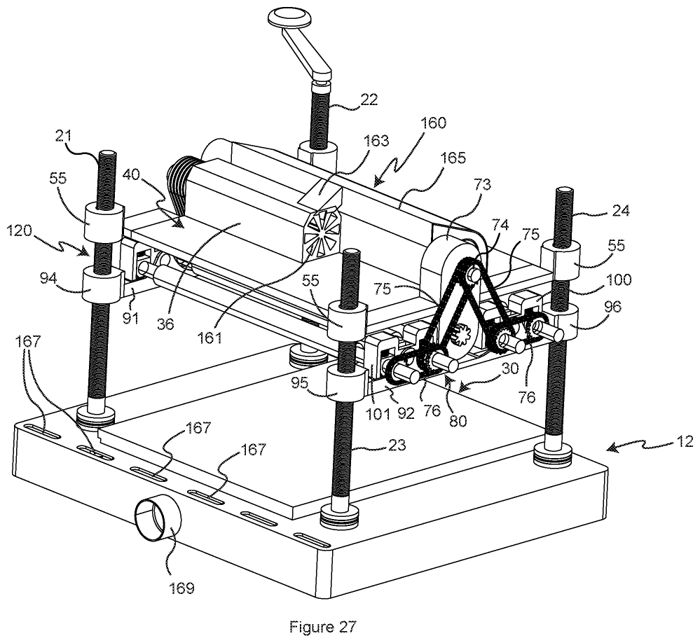

The planer further includes an air stream flow control apparatus which can control the flow of air through regions of the planer. The purpose of the control apparatus is to disperse dust laden air, which can be created during the operation of the planer. The apparatus comprises two systems. The first system is a downdraft system 160 which can direct an air flow from above towards the table 30. The downdraft system 160 is illustrated in FIGS. 27, 34 and 35. The system 160 includes an air inlet 161 which is formed in the motor housing 36. A flow generator (not shown) is arranged to draw air into the motor housing 36 through the inlet 161. The flow generator may be in the form of a fan operatively mounted to the motor driveshaft 37. The system 160 further includes an air stream guide 165 mounted to the cutter carriage 40 and arranged to direct air through the aperture 53 towards the table 30. A transfer duct 163 directs air from the motor housing 36 to the guide 165. The guide 165 includes a series of spaced apart separators 166 which assists in distributing the airflow so as to provide additional airflow control. The airstream guide comprises a passage 164 including an upstream section 164A, an intermediate section 164B and a downstream section 164C. The upstream section 164A tapers inwardly towards the intermediate section 164B and the downstream section 164C tapers outwardly from the intermediate section 164B towards through hole 53 with which it is in fluid communication. This configuration creates a Venturi effect with the lowest velocity being at the upstream section, the highest velocity at the intermediate section and a further lower velocity at the downstream section. The velocity in the downstream section is higher than that in the upstream section. The curved surface 164D of the passage 164 in the intermediate section 164B provides for a Coanda effect which assists in directing the airstream flow to the region where the cutting operation takes place. The system further includes slots 167 in the base section through which the downstream air can pass. This is clearly illustrated in FIGS. 26 to 29. The slots 167 are in communication with discharge port 169 which is operatively connected to a flow generator so as to extract air therethrough. A partition wall 168 separate slots and the extraction port from the other part of the recess 15. The two systems may be operable simultaneously.

The apparatus further includes an updraft system 170 which is operable to draw air away from the table 30. The updraft system 170 includes the hood 172 having an open underside in fluid communication with through hole 50. The hood has an outlet port 173 which can be operatively connected to a suitable flow generator.

FIG. 36 is a schematic illustration of yet another embodiment of the thickness planer. The planer of this embodiment is of similar structure to that described with reference to FIGS. 24 to 35 and where possible the same reference numerals have been used in FIG. 36 to identify the same parts as shown in FIGS. 24 to 35. The thickness planer according to this embodiment differs from that described with reference to FIGS. 24 to 35 in that each roller assembly 100 and 101 comprises a single roller only. These rollers are identified by the reference numerals 104A being a roller 104A upstream of the cutter assembly 60 and 106A being a roller 106A downstream of the cutter assembly 60. The rollers 104A and 106A are fitted to bushing block which are mounted to the support rails 91 and 92. In certain embodiments, the roller assemblies 100 and 101 may be a combination of single rollers as shown in FIG. 36 and two rollers as shown in FIGS. 24 to 27. The single roller in these embodiments may be upstream or downstream of the cutter assembly with the two roller assembly being oppositely positioned.

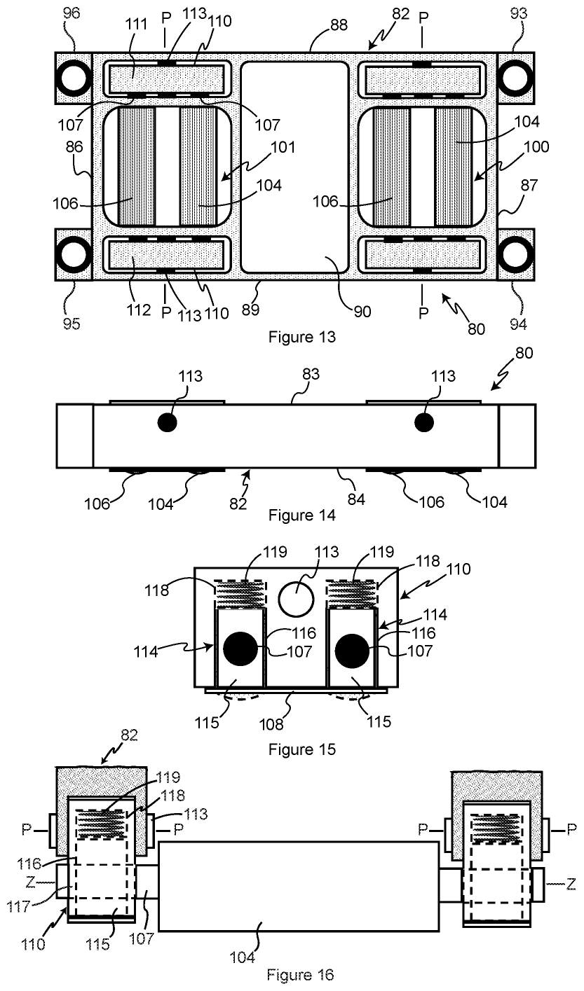

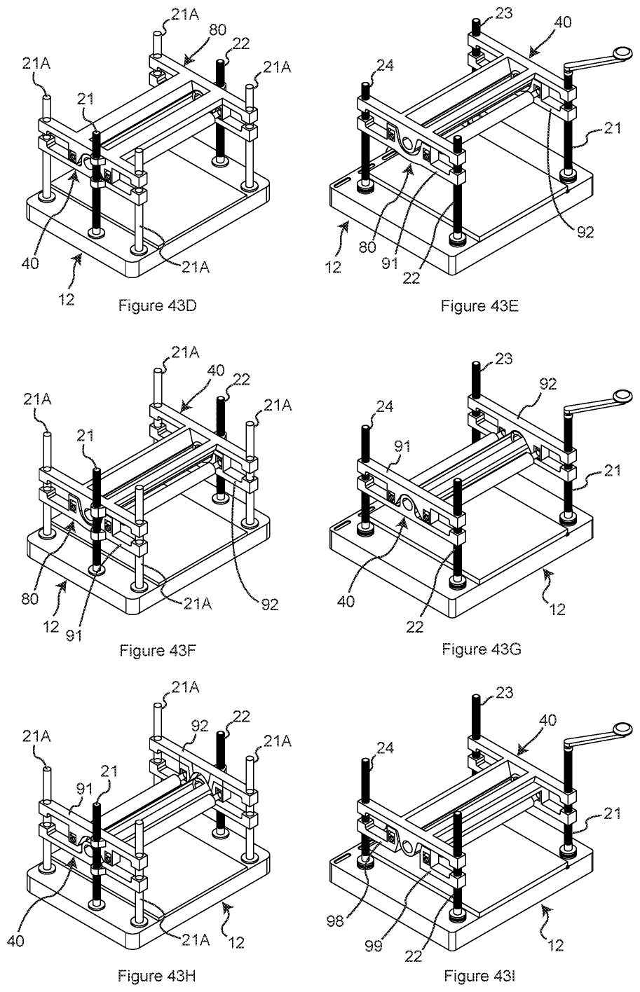

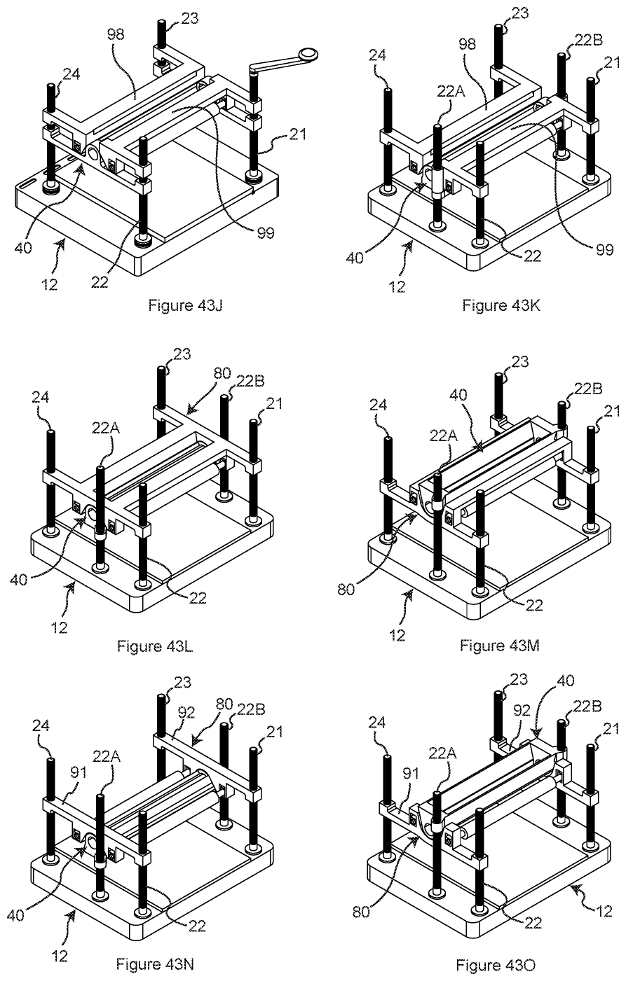

As shown in FIGS. 43A to 430, the configuration of the support, the cutter carriage and the roller carriage can take many different forms. In each embodiment described the upstream and downstream roller assemblies comprise a single roller. It will be readily apparent that the single roller could be replaced by the dual roller assemblies as described for example with reference to FIGS. 13 to 16.

In FIG. 43A, the support comprises four columns 21, 22, 23 and 24 each having a threaded section thereon and to which the cutter carriage 40 and roller carriage 80 are operatively mounted. In this embodiment, the cutter carriage 40 is mounted above the roller carriage 80.

In the embodiment of FIG. 43B the cutter carriage 40 and the roller carriage 80 are operatively mounted to threaded columns 21 and 22 as well as non-threaded guide columns 21A.

The embodiments shown in FIGS. 43C and 43D are similar to those illustrated in FIGS. 43A and 43B except that the roller carriage 80 is mounted above the cutter carriage 40. As is apparent however the rollers are positioned closer to the base 12 than the cutter.

The embodiments shown in FIGS. 43E and 43F are similar in structure to that shown in FIGS. 43A and 43B except that in the embodiment that roller carriage is not a unitary body but rather comprises two separate and spaced apart side rails 91 and 92 with the rollers extending therebetween. FIGS. 43G and 43H are substantially the same except the roller carriage is mounted above the cutter carriage.

In the embodiment of FIGS. 431 and 43J the roller carriage 80 comprises two separate end sections 98 and 99 mounted upstream and downstream of the cutter. In the embodiment of FIG. 431 the cutter carriage 40 is mounted above the roller carriage and in FIG. 43J the roller carriage is mounted above the cutter carriage 40.

In the embodiment of FIG. 43K there are two roller carriage end sections 98 and 99. Roller carriage end section 98 is mounted to columns 23 and 24, and roller carriage end section 99 is mounted to columns 21 and 22. The cutter carriage 40 is mounted to columns 22A and 22B. In FIG. 43L, the roller carriage 80 is a one-piece structure mounted to columns 21, 22, 23 and 24. Cutter carriage 40 is positioned below the roller carriage and is mounted to columns 22A and 22B. In FIG. 43M, the structure is similar to FIG. 43L except that the cutter carriage is mounted above the roller carriage. In FIG. 43N, the roller carriage 80 comprises two side parts, one being mounted to columns 21 and 23, and the other to columns 22 and 24. The roller carriage 40 is mounted to columns 22A and 22B and is positioned below the roller carriage. In FIG. 400, the structure is similar to FIG. 43N except that the cutter is mounted above the roller carriage.

In the forgoing description of preferred embodiments, specific terminology has been resorted to for the sake of clarity. However, the invention is not intended to be limited to specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In this specification the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, addition and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g. aspects of one embodiment may be combined with aspects of another embodiment to realise yet other embodiments. Further, each independent feature or component of any given assembly may constitute an additional embodiment.

The reference numerals in the following claims do not in any way limit the scope of the respective claims.

TABLE OF PARTS

| | | | |
|---|---|---|---|
| Thickness planer | 10 | Cutter assembly | 60 |
| Main body | 11 | Cutter head | 62 |
| Base structure | 12 | Cylindrical body | 64 |
| Underside | 13 | Outer peripheral surface | 65 |
| Top side | 14 | Cutter elements | 66 |
| Recess | 15 | Drive shaft | 68 |
| Column mounts | 16 | Pulleys | 67, 69 |
| Bosses | 17 | Bearings | 70, 71 |
| Nut | 18 | Belts | 72 |
| Flange | 19 | Gearbox | 73 |
| Support structure | 20 | Sprocket | 74 |
| Columns | 21, 22, 23, 24 | Chains | 75 |
| Columns | 21A, 22A, 22B | Connector chains | 76 |
| Thrust bearings | 25, 26 | Gear cog | 77 |
| Transmission arrangement | 27 | Rotation axis | Y-Y |
| Sprocket | 28 | Roller carriage | 80 |
| Chain | 29 | Main body | 82 |
| Table | 30 | Top side | 83 |
| Infeed end | 31 | Bottom side | 84 |
| Outfeed end | 32 | Ends | 86, 87 |
| Top surface | 33 | Sides | 88, 89 |
| Crank handle | 35 | Opening | 90 |
| Motor housing | 36 | Support rails | 91, 92 |
| Drive shaft | 37 | Mounts | 93, 94, 95, 96 |
| Cutting zone | 38 | End Sections | 98, 99 |
| Travel path | X-X | Roller assembly | 100 |
| Cutter carriage | 40 | Roller assembly | 101 |
| Main section | 42 | Leading roller | 104, 104A |
| Ends | 43, 44 | Trailing roller | 106, 106A |
| Sides | 45, 46 | Rotation axis | Z-Z |
| Top | 47 | Roller ends | 102, 103 |
| Bottom | 48 | Axle | 107 |
| Apertures | 50, 51, 52 | Roller support frame | 110 |
| Cutter head support section | 58 | First frame section | 111 |
| Mountings | 55 | Second frame section | 112 |
| Tubular members | 56 | Ends | 155, 156 |
| Pivot pin axis | P-P | Downdraft system | 160 |
| Connector assembly | 114 | Pivot pin | 113 |
| Bushing block | 115 | Inlet | 161 |
| Housing | 116 | Transfer duct | 163 |
| Slot | 117 | Airstream guide | 165 |
| Closure | 108 | Separators | 166 |
| Pressure applicator | 118 | Slots | 167 |
| Spring | 119 | Partition wall | 168 |
| Leaf Spring | 105 | Discharge port | 169 |
| Adjustment mechanism | 120 | Updraft system | 170 |
| Actuator | 121 | Hood | 172 |
| Actuator body | 122 | Outlet port | 173 |
| Head | 123 | Lug nuts | 180, 181 |
| Shank | 124 | Cylindrical body | 183 |
| Ends | 125, 126 | Collar | 184 |
| Thrust bearings | 127, 128 | Cogwheel | 186 |
| Lock nut | 129 | Activating nut | 187 |
| Air stream guide | 130 | Thrust bearings | 188 |
| Feed section | 131 | Lock nuts | 189 |
| Main body | 132 | Teeth | 182 |
| Side walls | 133 | | |
| Top wall | 134 | | |
| Underside | 135 | | |
| Chamber | 136 | | |
| Inlet | 137 | | |
| Discharge section | 140 | | |
| Main body | 141 | | |
| Side walls | 142 | | |
| Top wall | 143 | | |
| Ducts | 144 | | |
| Internal walls | 145 | | |
| Workpiece | 150 | | |
| Board | 151 | | |
| Top side | 152 | | |
| Bottom side | 154 | | |

1. A thickness planer comprising a main body which includes a base structure and a support structure, a cutter carriage configured to have a cutter assembly operatively mounted thereto, when in an installed position, and a roller carriage configured to have at least one roller assembly operatively mounted thereto, when in an installed position the roller assembly including at least one roller, the cutter carriage and the roller carriage each being mounted to the support structure above and in spaced relation from the base structure and arranged so that when the thickness planer is in an in use configuration, the cutter carriage and roller carriage are substantially isolated or separated from one another.

2. The thickness planer according to claim 1, wherein the base structure includes a table having a surface for supporting a workpiece as it moves along a workpiece travel path (X-X) from an infeed end towards an outfeed end, and wherein the cutter assembly and said at least one roller is/are arranged to contact the workpiece as it moves along the workpiece travel path through an opening between the roller and cutter carriages and the surface of the table.

3. The thickness planer according to claim 1, wherein said at least one roller is configured to be urged in a direction towards the base structure, and, wherein said at least one roller is optionally a driven roller for moving the workpiece along the workpiece travel path.

4. (canceled)

5. The thickness planer according to claim 1, wherein there are two roller assemblies mounted to the roller carriage when in the installed position in spaced apart relation to one another in the direction of the travel path axis (X-X), the cutter carriage and the roller carriage being configured so that the cutter assembly when in the installed position is disposed between the roller assemblies.

6. The thickness planer according claim 1, wherein the cutter carriage and the roller carriage are operatively mounted to the support structure independently of one another.

7. The thickness planer according to claim 1, wherein the cutter carriage includes a main section operatively mounted to the support structure and a cutter support section to which the cutter assembly is mounted, the cutter support section extending away from the main section towards the base structure, the roller carriage including a main body operatively mounted to the support structure, the main body having an opening therein which can receive the cutter support section.

8. The thickness planer according to claim 1, wherein the cutter carriage is positioned adjacent the base structure and the roller carriage is positioned above the cutter carriage when in the installed position.

9. These thickness planer according to claim 1, wherein the roller carriage is positioned adjacent the base structure and the cutter carriage is positioned above the roller carriage, the carriages being in spaced apart relation with respect to one another.

10. The thickness planer according to claim 2, wherein the roller carriage comprises two separate support rails laterally spaced apart with respect to the travel path axis (X-X), the rails being operatively mounted to the support structure and the or each roller assembly being operatively mounted to the support rails when in the installed position.

11. The thickness planer according to claim 1, wherein the carriage comprises two spaced apart and separated end sections each being operatively mounted to the support structure and each having a roller assembly operatively mounted thereto one being upstream of the cutter and the other being downstream of the cutter when in the installed position.

12. The thickness planer according to claim 2, wherein one or both of the roller assemblies comprise two rollers, one being a forward roller and the other a trailing roller, the rollers being mounted to a support frame which is pivotally mounted to the roller carriage for pivotal movement about a pivot axis (P-P) the pivot axis (P-P) extending laterally with respect to the travel path axis (X-X), the rollers being located on opposite sides of the pivot axis (P-P).

13. The thickness planer according to claim 2, wherein said at least one roller assemblies comprises at least one roller operatively mounted to the or each roller carriage, wherein the support frame optionally comprises first and second frame sections each being pivotally mounted to the roller carriage in spaced apart relation with respect to one another, wherein the forward and trailing rollers have ends operatively connected to respective ones of the first and second frame sections.

14. (canceled)

15. The thickness planer according to claim 13, wherein the ends of the rollers are operatively mounted to the frame sections so as to be displaceable in a lateral direction with respect to the roller axes and the pivot axis (P-P), the thickness planer further optionally, including a pressure applicator for urging the rollers in a direction towards the base structure in a substantially resilient fashion, wherein the pressure applicator optionally comprises springs mounted so as to bias the rollers in the direction towards the base structure.

16-17. (canceled)

18. The thickness planer according to claim 2, wherein the or each roller assembly comprises a single roller operatively mounted to the roller carriage.

19. The thickness planer according to claim 1, including an adjustment mechanism for adjusting the relative position of the base structure and the carriages towards or away from one another.

20. The thickness planer according to claim 19, including any one combination of:
the cutter assembly on the cutter carriage and at least one roller of the roller carriage are being maintained in a position relative to one another when the position of the carriages is adjusted relative to the base structure;
the adjustment mechanism being configured to cause the roller carriage and the cutter carriage to move in a synchronized fashion towards or away from the base structure;
the adjustment mechanism being configured to hold the roller carriage and the cutter carriage in a position above and spaced from the base structure; and
the adjustment mechanism being operable to move the carriages towards or away from the base structure.

21-23. (canceled)

24. The thickness planer according to claim 1, including any one or combination of:
the support structure comprising a plurality of columns operatively mounted to the base structure, the cutter carriage and roller carriage each comprising carriage mounts, the mounts being operatively connected to the columns so as to be movable therealong towards or away from the base structure;
the carriage mounts for each of the roller carriage being operatively connected to the same columns and in spaced relation with respect to one another;
the cutter carriage mounts being operatively connected to a first group of columns and the roller carriage mounts are operatively mounted to a second/separate group of columns;
the adjustment mechanism comprising cooperating threaded sections one being on the columns and the other associated with the carriage and roller mounts, the threaded sections being configured so that relative rotation therebetween causes the carriages to move along the columns;
the columns being mounted for rotation on the base structure so that rotation thereof causes movement of the carriages along the columns; and
the thickness planer further including a transmission arrangement for facilitating simultaneous rotation of the columns.

25-29. (canceled)

30. The thickness planer according to claim 1, further including any one or combination of:
a power train for powering the cutter head and the roller assemblies, the power train comprising a motor and a first transmission system operatively connecting the motor to the cutter head and a second transmission system operatively connecting the motor to the roller assemblies;
an air stream flow control apparatus for controlling a flow of air through regions of the planer, the air stream flow control apparatus including a first downdraught system which can direct an airflow from above towards the base structure, and a second updraft system, which is operable to draw air away on the base structure in an upwards direction; and
an airstream guide including a feed section with an internal chamber therein and inlet for delivering an airstream to the internal chamber, the guide further including a discharge section which includes a plurality of ducts in fluid communication with the internal chamber for directing the airstream towards the base structure.

31-32. (canceled)

33. A roller assembly for use in a thickness planer, the roller assembly comprising a roller support frame mounted for pivotal movement about a pivot axis (P-P), two rollers each having a rotation axis, the rollers being mounted to the support frame, the roller rotation axes being substantially parallel to the pivot axis (P-P) with one roller being located to one side of the pivot axis (P-P) and the other roller being located to the other side of the pivot axis (P-P), the roller assembly optionally including any one or combination of:
the support frame comprising first and second frame sections each being mounted for pivotal movement about the pivot axis (P-P) and in spaced apart relation with respect to one another, the rollers having ends which are operatively connected to respective ones of the first and second frame sections;
the ends of the rollers being operatively mounted to the frame sections so as to be laterally movable with respect to the roller axis and the pivot axes in a lateral direction towards an operative position; and
a pressure applicator being included for urging the rollers in the lateral direction towards the operative position, wherein the pressure applicator optionally comprises springs associated with each end of the rollers for biasing the rollers in the lateral direction towards the operating position.

34-37. (canceled)

38. An airstream flow control apparatus for a thickness planer, the thickness planer including a base structure, a support structure and a cutter carriage, the airstream flow control apparatus being operatively mounted to the cutter carriage when installed and comprising a downdraft system for directing a flow of air from the cutter carriage towards the base structure and an updraft system for drawing air away from the support structure.
